(19) United States
(12) Patent Application Publication
(10) Pub. No.: US 2014/0293136 A1
(43) Pub. Date: Oct. 2, 2014

(54) ILLUMINATION DEVICE, DISPLAY DEVICE, TELEVISION RECEIVING DEVICE, AND ILLUMINATION DEVICE MANUFACTURING METHOD

(71) Applicant: SHARP KABUSHIKI KAISHA, Osaka (JP)

(72) Inventor: Hirokazu Mouri, Osaka (JP)

(73) Assignee: SHARP KABUSHIKI KAISHA, Osaka (JP)

(21) Appl. No.: 14/353,729

(22) PCT Filed: Oct. 19, 2012
(86) PCT No.: PCT/JP2012/077099

§ 371 Date: Apr. 23, 2014

(30) Foreign Application Priority Data
Oct. 27, 2011 (JP) 2011-236048

(51) Int. Cl. F21V 8/00; H04N 5/44

(52) U.S. Cl. CPC G02B 6/009; G02B 6/0011; H04N 5/44
USPC 348/725; 362/611; 349/65; 29/825

(57) ABSTRACT

An illumination device 12 includes a light source 17; a light guide plate 16 having a light-receiving face 16b and a light-exiting surface 16a; a chassis 14 having a body 141 covering a rear surface 16c of the light guide plate 16, a strip-shaped projecting part 142 projecting beyond the light-receiving face 16b, and a straight edge 143 extending in a straight line parallel with the light-receiving face 16b; a light source support member 19 having a support part 191 supporting the light source 17, and an attachment part 192 having an edge 193 that extends beyond the straight edge 143 of the chassis 14 and that extends in a straight line parallel with this straight edge 143, the attachment part 192 being attached to the front side of the projecting part 142; a screw 21 penetrating the projecting part 142 and the attachment part 192 from the rear side of the projecting part 142; and a screw-receiving part 131 that clamps the projecting part 142 and the like between the screw 21 and the screw-receiving part 131 itself.

### TECHNICAL FIELD

The present invention relates to an illumination device, display device, television receiver, and a method of manufacturing the illumination device.

### BACKGROUND ART

A display device having a liquid crystal panel is also provided with an illumination device (a so-called backlight device) in addition to the liquid crystal panel. The illumination device is arranged on the rear side of the liquid crystal panel and is configured such that planar light is emitted towards the back surface of the liquid crystal panel. Liquid crystal panels cannot emit light on their own, and thus need to use light from the illumination device to display images.

A so-called edge-lit (side-lit) illumination device that has a light guide plate made of a transparent plate-shape member and a light source facing the edge face of this light guide plate is known as such an illumination device, as shown in Patent Document 1, for example. In this type of illumination device, the light guide plate and the light source are arranged on a plate-shaped chassis while maintaining a prescribed positional relationship and are attached to the chassis in this state. The light source is attached to the chassis by being supported by a prescribed support member.

### RELATED ART DOCUMENT

### Patent Document

Patent Document 1: Japanese Patent Application Laid-Open Publication No. 2010-60862

### Problems to be Solved by the Invention

The support member supporting the light source is fixed to the chassis by a screw inserted from the rear side of the chassis. In such a case, if the support member is completely covered by the chassis, then the exact location of the support member cannot be verified from the rear side of the chassis.

If the screw is used to fix the support member to the chassis without knowing the exact location of the support member, then the support member will deviate from the original attachment location thereof. If the support member deviates from the attachment position thereof, then variation will occur in the gap (distance) between the light guide plate and the light source, thereby causing uneven brightness in the planar light emitted from the illumination device.

The support member itself sometimes becomes deformed before being attached to the chassis. During attachment of the light source to the support member, or during attachment of the support member to other members at the time of assembling the display device, the support member, which has been pre-formed into a prescribed shape, may become deformed due to unwanted stress on the support member, for example. After the support member is deformed in this manner, the gap (distance) between the light source and the edge face of the light guide plate will be uneven if this support member is attached to the chassis, thereby becoming a cause of uneven brightness in the illumination device. Therefore, it is necessary to take measures such as restoring the deformed support member to the original shape thereof during attachment of the support member. However, if the support member is covered by the chassis, as described above, then the deformation of the support member cannot be verified from the rear side of the chassis, and this poses a problem.

### SUMMARY OF THE INVENTION

The present invention aims at providing an illumination device having a structure in which it is possible to verify, from the rear side of the chassis, the location or deformation of a light source support member fixed to the chassis by a screw inserted from the rear side of the chassis, a display device provided with this illumination device, a television receiver provided with this display device, and a method of manufacturing the illumination device.

### Means for Solving the Problems

An illumination device according to the present invention includes a light source; a light guide plate that is a plate-shaped member, having a light-receiving face including at least one edge face of the plate-shaped member where light from the light source enters, and a light-exiting surface including a front surface of the plate-shaped member from which the light that has entered from the light-receiving face exits; a chassis having a body covering a rear surface of the light guide plate, a strip-shaped projecting part extending from the body and projecting further outwards than the light-receiving face, and a straight edge including an edge of the projecting part and extending in a straight line along the light-receiving face; a light source support member having a support part supporting the light source such that the light source faces the light-receiving face with a prescribed gap being maintained therebetween, and an attachment part extending from the support part and being attached to a front surface of the projecting part while having an edge protruding further than the straight edge of the chassis, this edge of the attachment part extending in a straight line parallel to this straight edge of the chassis; screws penetrating the projecting part and the attachment part from a rear surface side of the projecting part; and screw-receiving parts respectively receiving tips of the screws and clamping the projecting part and the attachment part therebetween.

The attachment part of the light source support member is fixed by the screws and the screw-receiving parts while being attached to the rear surface of the projecting part. The screws penetrate the projecting part and the attachment part from the rear side of the projecting part to be respectively received by the screw-receiving parts. When the attachment part is attached to the rear surface of the projecting part, the edge of the attachment part protrudes outward from the straight edge of the chassis. In other words, the worker can verify the edge of the attachment part from the rear surface side of the projecting part. Therefore, in the illumination device, when attaching the light source support member to the chassis, it is possible to verify the location of the attachment part and whether or not deformation of the attachment part has occurred by comparing the edge of the attachment part to the straight edge of the chassis. In the illumination device, it is possible to attach the attachment part to the front surface of the projecting part while verifying the edge of the attachment part and extending this edge in a straight line along the straight edge of the chassis. In this state, deformation of the light source support member can be suppressed by the attachment part being fixed to the projecting part with the screws and screw-receiving parts.

In the above-mentioned illumination device, the projecting part may include a plurality of first penetrating holes along the straight edge of the chassis where the screws are respectively inserted, and the attachment part may include a plurality of second penetrating holes where the screws are respectively inserted such that the edge of the attachment part is protruding further than the straight edge of the chassis and this edge is extending in a straight line parallel to this straight edge. In the above-mentioned illumination device, when the first penetrating holes in the projecting part overlap the second penetrating holes in the attachment part, the attachment part of the light source support member is positioned with respect to the projecting part of the chassis.

In the above-mentioned illumination device, the attachment part may include a positioning part showing a position of the straight edge of the chassis when the attachment part is attached to the front surface of the projecting part. In the above-mentioned illumination device, when the positioning part is attached to the straight edge of the chassis, the attachment part is positioned with respect to the projecting part.

In the above-mentioned illumination device, the projecting part may include a plurality of first protrusions arranged along the straight edge of the chassis on the front surface of the projecting part, and the attachment part may include a plurality of first fitting holes that respectively fit with the first protrusions in a state in which the edge of the attachment part is protruding further than the straight edge of the chassis and this edge is extending in a straight line parallel to this straight edge. In the above-mentioned illumination device, the edge of the attachment part protrudes beyond the straight edge of the chassis and conforms to the straight edge in a straight line due to the first protrusions on the projecting part being fitted into the first holes in the attachment part.

In the above-mentioned illumination device, the projecting part may include a plurality of second fitting holes arranged along the straight edge of the chassis, and the attachment part may include a plurality of second protrusions that respectively fit with the second fitting holes such that the edge of the attachment part is protruding further than the straight edge of the chassis and this edge is extending in a straight line parallel to this straight edge. In the above-mentioned illumination device, the edge of the attachment part protrudes beyond the straight edge of the chassis and conforms to the straight edge in a straight line due to the second fitting holes in the attachment part being fitted into the first holes in the projecting part.

In the above-mentioned illumination device, the light source support member may be a heat dissipating member. In the above-mentioned illumination device, the number of components can be reduced by using the heat dissipating member as the light source support member.

In the above-mentioned illumination device, the chassis may be casted by a mold. In the above-mentioned illumination device, the chassis is casted by using a mold; therefore, the linearity of the straight edge of the chassis is ensured.

A display device of the present invention includes a display panel that displays images using light from the above-mentioned illumination device.

In the display device, the display panel may be a liquid crystal panel having liquid crystal.

A television receiver according to the present invention includes the display device.

According to the present invention, a method of manufacturing an illumination device having a light source; a light guide plate that is a plate-shaped member having a light-receiving face including at least one edge face of the plate-shaped member where light from the light source enters, and a light-exiting surface including a front surface of plate-shaped member from which the light that has entered from the light-receiving face exits; a chassis, having a body covering a rear surface of the light guide plate, a strip-shaped projecting part extending from the body and projecting further outwards than the light-receiving face, and a straight edge including an edge of the projecting part and extending in a straight line along the light-receiving face; a light source support member, having a support part supporting the light source such that the light source faces the light-receiving face while a prescribed gap is maintained therebetween, and an attachment part extending from the support part and being attached to a front surface of the projecting part while having an edge protruding further than the straight edge of the chassis, this edge of the attachment part extending in a straight line parallel to this straight edge of the chassis; screws penetrating the projecting part and the attachment part from a rear surface side of the projecting part; and screw-receiving parts respectively receiving tips of the screws and clamping the projecting part and the attachment part therebetween, includes: extending the edge of the attachment part protruding further than the straight edge of the chassis such that this edge is in a straight line parallel to this straight edge; penetrating the projecting part and the attachment part with the screws from the rear surface side of the projecting part; and clamping the projecting part and the attachment part between the screws and the screw-receiving parts.

### Effects of the Invention

According to the present invention, an illumination device having a structure in which it is possible to verify, from the rear side of the chassis, the location or deformation of a light source support member fixed to the chassis by a screw inserted from the rear side of the chassis, a display device provided with this illumination device, a television receiver provided with this display device, and a method of manufacturing the illumination device can be provided.

### BRIEF DESCRIPTION OF THE DRAWINGS

FIG. 1 is an exploded perspective view that shows a schematic configuration of a television receiver and a liquid crystal display device according to Embodiment 1 of the present invention.

FIG. 2 is a rear view of the television receiver and the liquid crystal display device.

FIG. 3 is an exploded perspective view showing a schematic configuration of a liquid crystal display unit that constitutes a part of the liquid crystal display device.

FIG. 4 is a partial cross-sectional view along the short side direction of the liquid crystal display unit.

FIG. 5 is a view of positional relationship between an outer frame, inner frame, and an LED unit.

FIG. 6 is a view of a projecting part and attachment part before these are combined together.

FIG. 7 is a view of the projecting part and attachment part after these are combined together.

FIG. 8 is a view of a deformed attachment member imposed on the projecting part.

FIG. 9 is a view of a projecting part of a chassis and an attachment part of a light source support member used in a liquid crystal display device of Embodiment 2.

FIG. 10 is a partial cross-sectional view along the short side direction of a liquid crystal display unit according to Embodiment 3.

FIG. 11 is a view of a projecting part of a chassis and an attachment part of a light source support member used in a liquid crystal display device of Embodiment 3.

FIG. 12 is a view of the projecting part of the chassis and the attachment part of the light source support member used in the liquid crystal display device of Embodiment 3 combined together.

FIG. 13 is a partial cross-sectional view along the short side direction of a liquid crystal display unit according to Embodiment 4.

### DETAILED DESCRIPTION OF EMBODIMENTS

### Embodiment 1

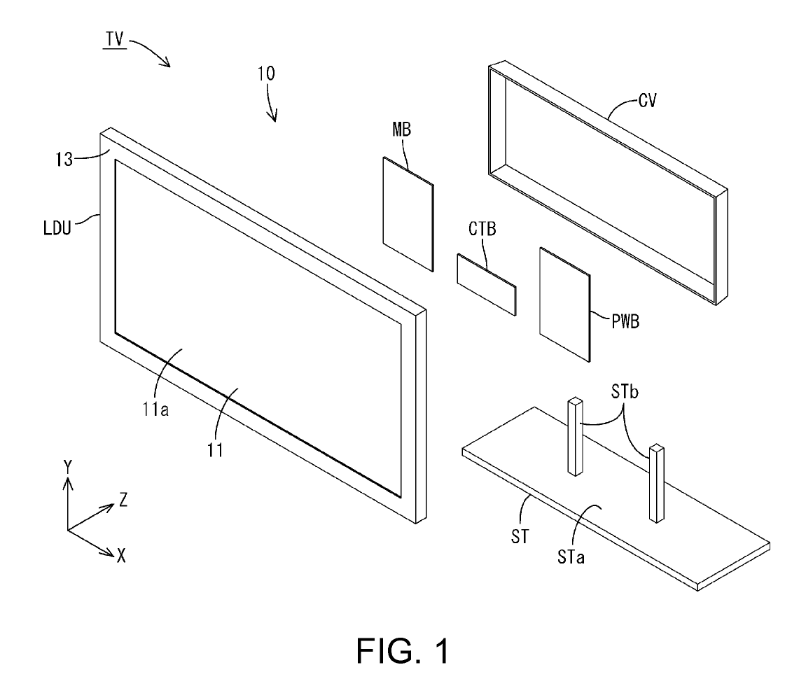

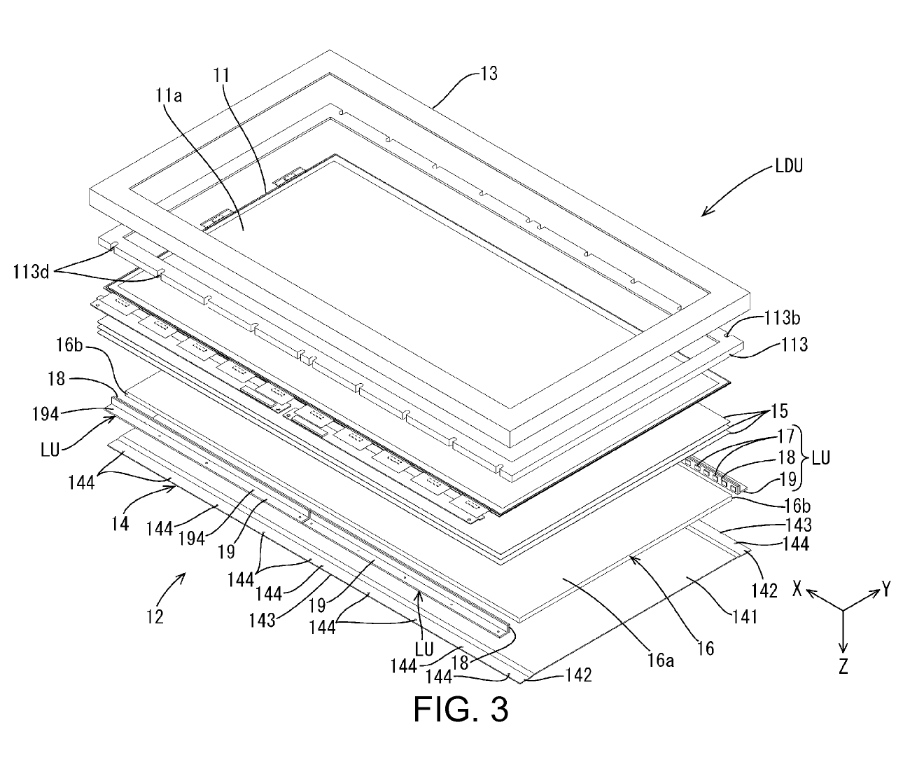

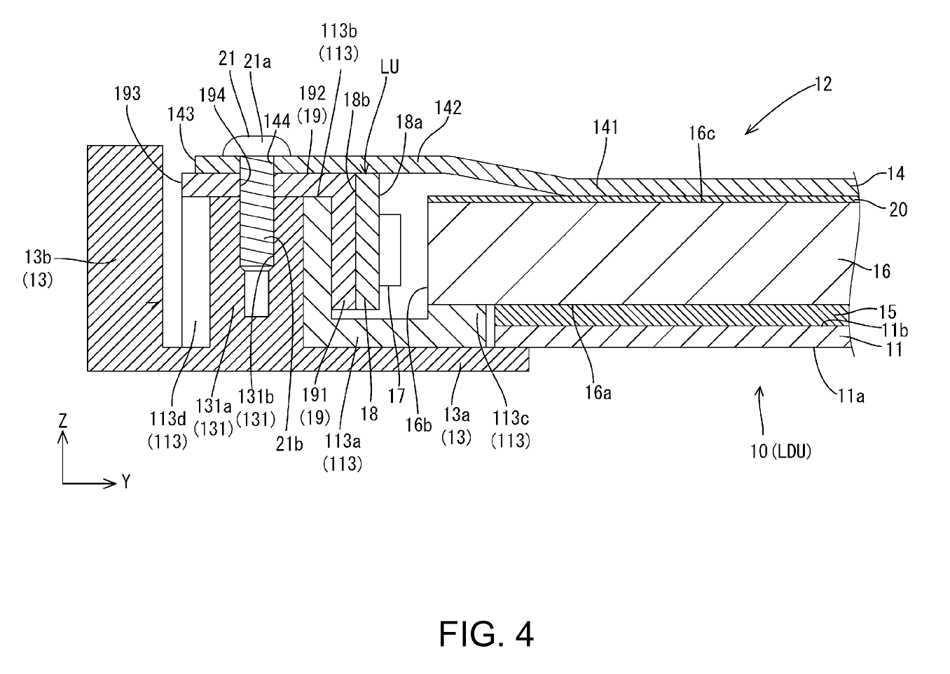

Embodiment 1 of the present invention will be explained below with reference to FIGS. 1 to 8. In the present embodiment, a liquid crystal display device 10 will be described as an example. An X axis, Y axis, and Z axis are shown in a part of every drawing, and the direction of these axes are drawn so as to be the same direction in every drawing. The top in FIG. 3 is the front side and the bottom is the rear side, and the bottom in FIG. 4 is the front side and the top is the rear side.

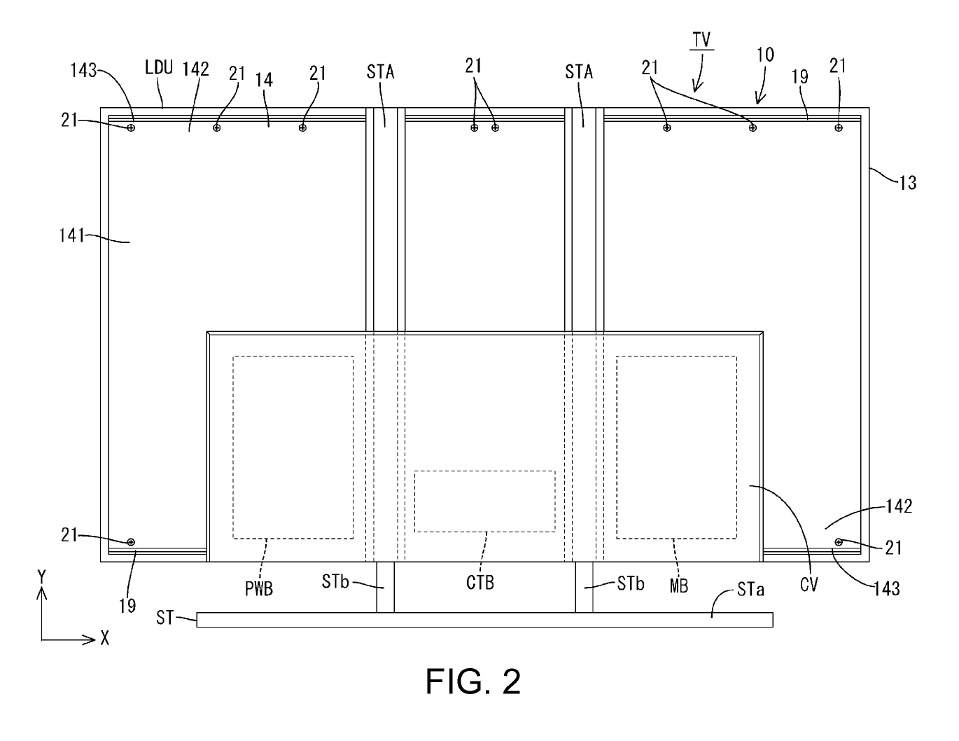

FIG. 1 is an exploded perspective view that shows a schematic configuration of a television receiver TV and the liquid crystal display device 10 according to Embodiment 1 of the present invention. FIG. 2 is a rear view of the television receiver TV and the liquid crystal display device 10. FIG. 3 is an exploded perspective view showing a schematic configuration of a liquid crystal display unit LDU that constitutes a part of the liquid crystal display device 10. As shown in FIG. 1, the television receiver TV of the present embodiment includes: the liquid crystal display unit LDU; various types of boards PWB, MB, and CTB attached to the rear side (rear side) of this liquid crystal display unit LDU; a cover member CV attached to the rear side of the liquid crystal display unit LDU and covering the various types of boards PWB, MB, and CTB; and a stand ST. The liquid crystal display unit LDU is supported by the stand ST such that the display surface of the liquid crystal display unit LDU is along the vertical direction (the Y axis direction).

The liquid crystal display device 10 of the present embodiment is the portion excluding at least the configuration for receiving television signals (such as a tuner part of the main board MB) from the television receiver TV having the above-mentioned configuration. As shown in FIG. 3, the liquid crystal display unit LDU has a horizontally-long rectangular shape as a whole, and has a liquid crystal panel 11, which is a display panel, and a backlight device (illumination device) 12, which is an external light source. These are held together as one component by an outer frame 13 and a chassis 14, which form the exterior of the liquid crystal display device 10.

As shown in FIG. 2, on the rear of the chassis 14 that constitutes the rear exterior of the liquid crystal display device 10, a pair of stand attachment members STA extending along the Y axis direction is attached at two locations that are separated from each other along the X axis direction. The cross-sectional shape of these stand attachment members STA is a substantially channel shape that opens towards the chassis 14, and a pair of support columns STb of the stand ST is inserted into respective spaces formed between the stand attachment members STA and the chassis 14, respectively. Wiring members (such as electric wires) connected to an LED substrate 18 of the backlight device 12 run through a space inside of the stand attachment members STA. The stand ST is constituted of a base STa that widens along the X axis direction and the Z axis direction, and a pair of support columns STb standing on the base STa along the Y axis direction. The cover member CV is made of a synthetic resin and is disposed over the pair of stand attachment members STA in the X axis direction while covering approximately the bottom half (see FIG. 2) of the rear of the chassis 14. Between the cover member CV and the chassis 14, a space is provided where the components described later such as the various boards PWB, MB, and CTB can be housed.

As shown in FIG. 2, the various boards PWB, MB, and CTB include a power supply board PWB, a main board MB, and a control board CTB. The power supply board PWB is a power supply source for the liquid crystal display device 10, and supplies driving power to the other boards MB and CTB, LEDs 17 of the backlight device 12, and the like. The main board MB has a tuner (not shown) capable of receiving television signals and an image processor (not shown) that processes the received television signals. The processed image signals are outputted to the control board CTB. When the liquid crystal display device 10 is connected to an external image-reproduction device (not shown), the image signal from the image-reproduction device is inputted to the main board MB and processed at the image processor. The processed signal is outputted to the control board CTB. The control board CTB has the function of converting the image signal inputted from the main board MB into a signal for driving liquid crystal, and supplying this signal to the liquid crystal panel 11.

As shown in FIG. 3, the primary constituting components of the liquid crystal display unit LDU, which forms a part of the liquid crystal display device 10, are sandwiched between the outer frame (front frame) 13 arranged on the front side of the liquid crystal display device and the chassis (rear chassis) 14 arranged on the rear side of the liquid crystal display device. In the present embodiment, an inner frame 113 is fitted to the rear side (the top in FIG. 4) of the frame 13. Included in the primary constituting components sandwiched between the outer frame 13 and the chassis 14 are at least the inner frame 113, the liquid crystal panel 11, optical members 15, a light guide plate 16, and LED units (light source units) LU. Of these, the liquid crystal panel 11, optical members 15, and light guide plate 16 are alternately stacked one on top of the other and held by being sandwiched by the frame 13 on the front side and the chassis 14 on the rear side. The backlight device 12 is mainly constituted of the optical members 15, the light guide plate 16, the LED units LU, the chassis 14, screws 21, and screw-receiving parts 131. The screw-receiving parts 131 are part of the outer frame 13, as described later. The LED units LU that form a part of the backlight device 12 face both sides of the light guide plate 16 in the short side direction (Y axis direction) between the frame 13 and the chassis 14. Two of the LED units LU are arranged on each of the long sides of the light guide plate 16. The two LED units LU are arranged in a line along the respective long sides of the light guide plate 16. The LED unit LU is constituted of the LEDs 17, which are the light source, an LED substrate (light source substrate) 18 on which the LEDs 17 are mounted, and a light source support member 19 to which the LED substrate 18 is attached.

As shown in FIG. 3, the liquid crystal panel 11 has a horizontally-long rectangular shape in a plan view and has a pair of glass substrates having excellent light transmissive characteristics bonded together with a prescribed gap therebetween. Liquid crystal is sealed between these two substrates. On one substrate (an array substrate), switching elements (TFTs, for example) connected to source wiring lines and gate wiring lines that are orthogonal to each other, pixel electrodes connected to the switching elements, an alignment film, and the like are provided. On the other substrate (color filter substrate, hereinafter CF substrate) color filters (CF) each having a colored portion such as R (red), G (green), B (blue) or the like arranged in parallel, an opposite electrode, an alignment film, and the like are provided.

The liquid crystal panel 11 is stacked on the front side of the optical members 15, and the rear surface thereof (outer surface of a polarizing plate on the rear side) is in close contact with the optical members 15 with almost no gap therebetween. This mitigates the occurrence of dust or the like entering between the liquid crystal panel 11 and the optical members 15. A display surface 11a of the liquid crystal panel 11 is constituted of an area that is in the center of the screen and that can display images, and a non-display area that is on the periphery of the screen and that is formed in a frame shape surrounding this display area. The liquid crystal panel 11 is connected to the control board CTB via driver components or a flexible substrate for driving liquid crystal, and an image is displayed in the display area on the display surface 1 la thereof on the basis of signals inputted from the control board CTB. Polarizing plates are respectively provided on outer sides of the two substrates.

As shown in FIG. 3, the optical members 15 have a horizontally-long rectangular shape in a plan view, in a manner similar to the liquid crystal panel 11, and the size thereof (the short side dimensions and long side dimensions) are similar to the liquid crystal panel 11. The optical members 15 are stacked on the front side (light-exiting side) of the light guide plate 16. The optical members 15 are sandwiched between the liquid crystal panel 11 and the light guide plate 16. Each of the optical members 15 is a sheet-shaped member, and the optical members 15 are constituted of three sheets stacked together. Specific types of the optical members 15 include a diffusion sheet, lens sheet, reflective polarizing sheet, or the like, for example, and these may be chosen and used as appropriate.

The light guide plate 16 is made of a substantially transparent (having excellent light transmissive properties) synthetic resin (an acrylic resin such as PMMA or polycarbonate, for example) with a refractive index sufficiently higher than air. As shown in FIG. 3, the light guide plate 16 has a horizontally-long rectangular shape in a plan view, in a manner similar to the liquid crystal panel 11 and optical members 15, and also has a plate shape that is thicker than the optical members 15. The long side direction of the surface of the light guide plate coincides with the X axis direction, and the short side direction of the surface coincides with the Y axis direction. The plate thickness direction (thickness direction) perpendicular to the surface of the light guide plate coincides with the Z axis direction. The light guide plate 16 is arranged so as to overlap the rear side of the optical members 15 and is sandwiched between the optical members 15 and the chassis 14. The light guide plate 16 is sandwiched in the Y axis direction between the pair of LED units LU disposed on both edges of the light guide plate 16 facing each other in the short side direction thereof. Light from the LEDs 17 enters both respective edges of the short side direction. The light guide plate 16 has the function of propagating therethrough the light of the LEDs 17 that entered from the respective short side edges and emitting the light towards the optical members 15 (front side).

Of the main surfaces of the light guide plate 16, the front surface (surface facing the optical members 15) is a light-exiting surface 16a where light exits from the interior towards the optical members 15 and the liquid crystal panel 11. Of the peripheral edge faces of the light guide plate 16 adjacent to the surface thereof, both lengthwise edge faces of the long side along the X axis direction respectively face the LEDs 17 (LED substrates 18) with a prescribed gap therebetween. These are light-receiving faces 16b on which light emitted from the LEDs 17 is radiated. These light-receiving faces 16b expand along the X axis direction and the Z axis direction (surface of the LED substrates 18) and are substantially perpendicular to the light-exiting surface 16a. The direction in which the LEDs 17 and the light-receiving faces 16b are aligned coincides with the Y axis direction.

As shown in FIG. 4, a reflective sheet 20 capable of reflecting light emitted to outside of the rear side from a surface 16c of the light guide plate 16 back towards the front side is disposed on the rear surface 16c of the light guide plate 16 (in other words, the surface opposite to the light-exiting surface 16a). The reflective sheet 20 covers substantially the entire surface 16c of the light guide plate 16. This reflective sheet 20 is sandwiched between the chassis 14 and the light guide plate 16. The reflective sheet 20 is made of a synthetic resin, and the surface thereof is a highly reflective white. The reflective sheet 20 has substantially the same shape as the surface of the light guide plate 16. Reflective parts (not shown) that reflect internal light or scattering dots (not shown) that scatter internal light are patterned with a prescribed planar distribution on at least one of the light-exiting surface 16a and the surface 16c opposite thereto of the light guide plate 16. This controls the light from the light-exiting surface 16a such that the light has a uniform planar distribution.

Next, the LEDs 17, LED substrate 18, and light source support member 19 that constitute the LED unit LU will be explained in that order. As shown in FIGS. 3 and 4, the LEDs 17 are each constituted of an LED chip sealed by a resin material to a substrate part, which is fixed to the LED substrate 18. The LED chip mounted on the substrate part has one type of primary light-emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of the LED chips and the fluorescent material causes white light to be emitted overall. The fluorescent material is appropriately combined from a yellow fluorescent material that emits yellow light, a green fluorescent material that emits green line, and a red fluorescent material that emits red light, or the fluorescent material is only one of these, for example. These LEDs 17 are of a so-called top-type in which the surface of the LED substrate 18 opposite to the mounting surface is the light-emitting surface.

As shown in FIGS. 3 and 4, the LED substrate 18 has an elongated plate shape extending along the long side direction of the light guide plate 16 (X axis direction/lengthwise direction of the light-receiving faces 16b) and the surface of the LED substrate 18 is along the X axis direction and the Z axis direction (in other words, parallel with the light-receiving faces 16b of the light guide plate 16). The LED substrate 18 is arranged in the space between the frame 13 and the chassis 14. The LEDs 17 with the above-mentioned configuration are mounted on the front surface of the LED substrate 18 (namely, the surface facing the light guide plate 16), and this surface serves as a mounting surface 18a. A plurality of the LEDs 17 are arranged in a straight line with prescribed gaps therebetween along the long direction (X axis direction) of the mounting surface 18a of the LED substrate 18. A plurality of the LEDs 17 are intermittently arranged in parallel along the long side direction of both long side edge faces of the backlight device 12. The gaps between the LEDs 17 adjacent to each other in the X axis direction (namely, the array pitch of the LEDs 17) are substantially similar. The alignment direction of the LEDs 17 coincides with the length direction (X axis direction) of the LED substrates 18. Wiring patterns (not shown) made of a metal layer (copper foil or the like) extending along the X axis direction and going across the LEDs 17 are disposed on the mounting surface 18a of the LED substrates 18 and connect the adjacent LEDs 17 together in series. The terminals formed at both edges of these wiring patterns are connected to the power supply board PWB through wiring line members such as connectors or electric lines, thereby supplying driving power to the respective LEDs 17. The base material of the LED substrates 18 is a metal made of aluminum or the like, and the wiring patterns described above are formed on the surface of these LED substrates 18 through an insulating layer, for example. A solder resist layer is formed on the insulating layer in order to protect the wiring patterns. An insulating material such as ceramic may be used as the base material of the LED substrates 18.

The light source support member 19 is made of a heat dissipating member (a so-called heat sink) in order to cool the LEDs 17. Specifically, the light source support member 19 is made of a metal with excellent thermal conductivity, such as aluminum. The light source support member 19 has a shape like a metal plate bent at a right angle as a whole, and as shown in FIG. 4, the cross-section thereof is substantially “L”-shaped. The light source support member 19 is constituted of a support part 191 that supports the LED substrate 18, and an attachment part 192 that extends to this support part 191 and that attaches to the chassis 14.

The support part 191 is a portion that supports the LED substrate 18 from the surface 18b side of the rear surface of the LED substrate 18 and has an elongated plate-shape as a whole. As shown in FIGS. 3 and 4, the support member 191 rises towards the front side (towards the liquid crystal panel 11) from the chassis 14 in a state attached to the backlight device 12 (liquid crystal display device 10). The support member 191 is arranged along the long side direction (X axis direction) of the light guide plate 16 with a prescribed gap between the support member 191 and the light-receiving face 16b. In the present embodiment, the height of the support part 191 (the height from the chassis 14) is substantially the same as the length in the widthwise direction of the LED substrate 18.

The attachment part 192 has an elongated plate-shape as a whole and is attached to the chassis 14 so as to be fastened to the front side of the chassis 14. The attachment part 192 extends to the base of the support part 191 described above, and as shown in FIG. 4, extends towards the side opposite to the light guide plate 16 (in other words, towards the outside). An edge 193 of the attachment part 192 attaches to a prescribed location of the chassis 14 while protruding beyond an edge (straight edge) 143 of the chassis 14. The attachment part 192 has a plurality of screw holes (second penetrating holes) 194 arranged in a line in the length direction of the attachment part 192, and screws 21, described later, are respectively inserted into these screw holes 194.

The light source support member 19 is manufactured together with the support part 191 and the attachment part 192 by casting, extrusion molding, or the like. The screw holes 194 are drilled at a prescribed location on the attachment part 192. The light source support member 19 of the present embodiment is a heat dissipating member, as described above; therefore, the heat received from the LED substrate 18 can be transmitted to the chassis 14.

As shown in FIG. 3, the outer frame 13 has a frame shape that surrounds the display surface 11a of the liquid crystal display panel 11 and is made of a metal material such as aluminum. The outer frame 13 includes a frame-shaped front part 13a arranged on the front side of the liquid crystal display unit LDU (liquid crystal display device 10), and a frame-shaped peripheral wall 13b that surrounds the periphery of the liquid crystal display unit LDU (liquid crystal display device 10).

The inner edge of the frame-shaped front part 13a presses the periphery of the liquid crystal panel 11 from the front side thereof. The front part 13a presses the stacked body constituted of the liquid crystal panel 11, optical members 15, light guide plate 16, and reflective sheet 20 towards the chassis 14. The peripheral wall 13b is disposed on the outer edge of the front part 13a. The peripheral wall 13b extends towards the chassis 14 from the front part 13a and surrounds the liquid crystal panel 11, light guide plate 16, LED unit LU, and the like. As shown in FIG. 4, the cross-section of the front part 13a and the peripheral wall 13b is substantially “L”-shaped.

The screw-receiving part 131 is disposed on the rear side of the front part 13a. This screw-receiving part 131 is used when attaching the LED unit LU to the chassis 14. The screw-receiving part 131 is generally cylindrical and protrudes towards the chassis 14 from the rear side of the front part 13a. This screw-receiving part 131 is provided together with the front part 13a of the outer frame 13. In other words, the screw-receiving part 131 of the present embodiment is made of a metal material such as aluminum. A plurality of the screw-receiving parts 131 are provided on the two long sides of the front part 13a of the rectangular outer frame 13. The screw-receiving parts 131 are arranged in a row on the respective long sides of the front part 13a. The screw-receiving part 131 includes a cylindrical body 131a and a screw hole 131b in the center of this body 131a. The tip of the screw 21 is inserted into this screw hole 131b.

A frame-shaped inner frame 113 is arranged on the rear side of the front part 13a. This inner frame 113 is made of a synthetic resin and is smaller than the outer frame 13. The inner frame 113 is attached to the liquid crystal display unit LDU while overlapping the rear side of the outer frame 13. The inner frame 113 includes a frame-shaped front part 113a attached to the front part 13a of the outer frame 13, a frame-shaped peripheral wall 113b provided on the outer edge of this front part 113a, a pressing part 113c that is provided on the inner edge of the front part 113a and that presses the periphery of the light guide plate 16 from the front side thereof, and a plurality of cut-outs 113d provided on the outer edge of the peripheral wall 113b.

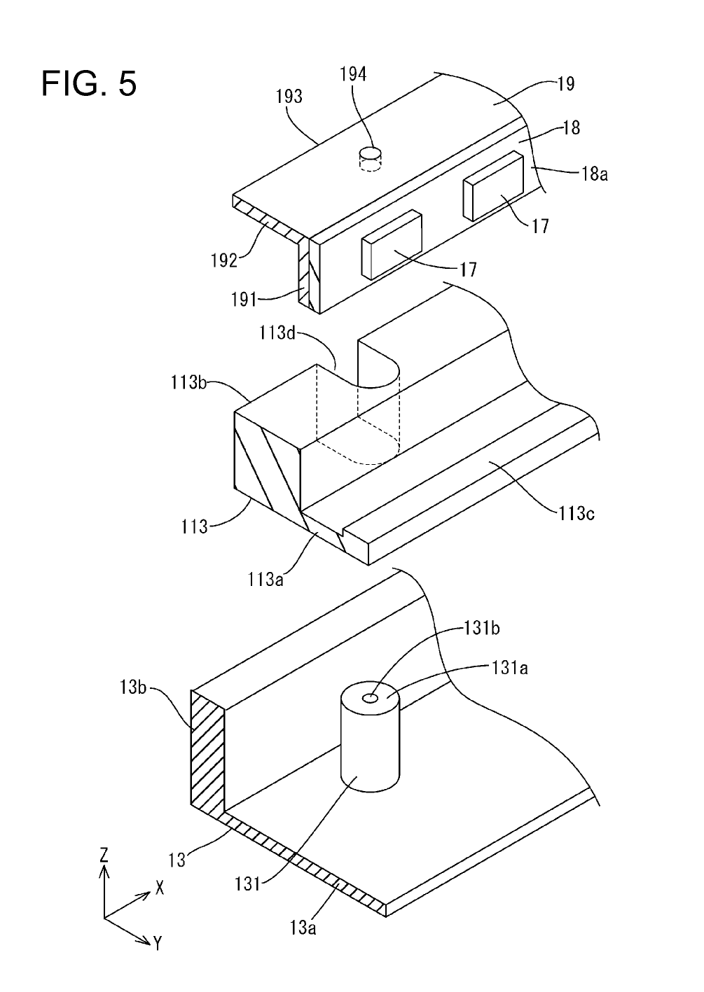

The inner edge (namely, the inner edge of the front part 113) of the inner frame 113 is farther inwards than the outer frame 13, and the inner frame 113 is configured so as to not protrude from the inner portion of the outer frame 13. The pressing part 113c in the inner edge of the inner frame 113 protrudes towards the chassis 14 from the front part 113, and this protruding portion presses the periphery of the front surface of the light guide plate 16 towards the chassis 14. In other words, the light guide plate 16 is sandwiched between the pressing part 113c of the inner frame 113 and the chassis 14. There is a slight gap between the outer edge of the inner frame 113 (namely, the peripheral wall 113b) and the peripheral wall 13b of the outer frame 13. FIG. 5 is a view of the positional relationship of the outer frame 13, inner frame 113, and LED unit LU. When the inner frame 113 overlaps the outer frame 13, the screw-receiving part 131 provided on the front part 13a of the outer frame 13 is inserted into the cut out 113d in the peripheral wall 113b of the inner frame 113. The cut out 113d is cut inwards from the outside of the peripheral wall 113b and penetrates the peripheral wall 113b in the thickness direction (the Z axis direction). As shown in FIG. 4, in the present embodiment, the height of the peripheral wall 113b (the height from the exterior chassis 13) is substantially the same as the height of the screw-receiving part 131.

The light source support member 19 of the LED unit LU is provided on the peripheral wall 113b of the inner frame 113. At such a time, the attachment part 192 of the light source support member 19 is attached to the surface facing the rear side of the peripheral wall 113b, and the support part 191 thereof is attached to the inner periphery of the peripheral wall 113b. The inner frame 113 is generally used when determining the attachment location of the LED unit LU when assembling the liquid crystal display unit LDU (the backlight device 12). At such a time, the screw holes 194 in the attachment part 192 of the light source support member 19 are positioned to coincide with the screw holes 131b of the screw-receiving parts 131.

The chassis 14 has a generally horizontally-long rectangular shape as a whole and is arranged on the rear side of the liquid crystal display unit LDU (liquid crystal display device 10). The chassis 14 includes a rectangular body 141 that covers the rear surface 16c of the light guide plate 16, and a projecting part 142 that projects from the long side of this body 141 towards the outside. This chassis 14 is a plate-shaped member made of a metal such as aluminum, and is molded into a prescribed shape using a mold, for example. The edge of the long side of the body 141 gradually inclines the farther it is away from the liquid crystal panel 11, and the projecting part 142 continues to outside this slanted portion.

The body 141 is closely adhered to the rear surface 16c of the light guide plate 16 through the reflective sheet 20. The short side edge of the rectangular body 141 is attached close enough to the peripheral wall 13b of the outer frame 13 such that there are substantially no gaps therebetween. The strip-shaped projecting part 142 that extends along the long side direction is provided on the long side edge of the body 141. As shown in FIG. 4, this projecting part 142 projects beyond the light-receiving face 16b of the light guide plate 16. A plurality of screw holes (first penetrating holes) 144 are disposed in the projecting part 142. These screw holes 144 are arranged in a line along the lengthwise direction (the long side direction of the chassis 14) of the projecting part 142. This projecting part 142 is used as an attachment spot for the LED units LU. When attaching the LED units LU, the screw holes 144 in the projecting part 142 align with the screw holes 194 in the light source support member 19. The edge 143 of the projecting part 142 extends in a straight line along the lengthwise direction (X axis direction) of the projecting part 142 and is called the straight edge 143.

The screws 21 are inserted so as to penetrate the chassis 14 and the light source support member 19 from the chassis 14 side towards the outer frame 13. The screws 21 are made of metal and used for fixing the LED units LU to the chassis 14. Each screw 21 is constituted of a head 21a and a shaft 21b that extends from this head 21. Spiral-shaped ridges are provided on the surface of the shaft 21b. As shown in FIG. 4, the tip of the screw 21 (in other words, the tip of the shaft 21b) is inserted into the screw hole 131b of the screw-receiving part 131. The diameter of the screw hole 131b of the screw-receiving part 131 is slightly smaller than the diameter of the shaft 21b of the screw 21 before the tip of the screw 21 is inserted. The diameter of the screw hole 144 in the chassis 14 and the diameter of the screw hole 194 in the light source support member 19 are slightly larger than the diameter of the shaft 21b of the screw 21. In other words, these screw holes 144 and 194 have a so-called looseness (leeway) allowing for deviations in attachment, size, and the like. The screws 21 engage the screw-receiving parts 131 while inserted into the screw holes 144 and 194, thereby sandwiching the projecting part 142 of the chassis 14 and the attachment part 192 of the light source support member 19 between the screw-receiving parts 131 and the screws 21. In the present embodiment, one LED unit uses five screws 21 to be fixed to the chassis 14.

The screw 21 engaging with the screw-receiving part 131 sandwiches the liquid crystal panel 11, optical members 15, light guide plate 16 and the like between the chassis 14 and the outer frame 13. As shown in FIGS. 2 and 4, the edge 193 of the light source support member 19 of the LED unit LU fixed to the chassis 14 protrudes outward from the edge (straight edge) 143 of the chassis 14. In other words, in the liquid crystal display unit LDU (backlight device 12) of the present embodiment, it is possible to confirm the attachment position of the LED units LU to the edge 143 of the chassis 14, when the liquid crystal display unit LDU is viewed from the rear side, based on the state of the edge 193 of the light source support member 19.

The assembling procedure (method of manufacturing) of the liquid crystal display unit LDU of the present embodiment will be explained. As shown in FIG. 4, the respective constituting components of the liquid crystal display unit LDU of the present embodiment are attached such that the front side is the bottom and the rear side is the top. First, the outer frame 13 is placed on a workbench (not shown). The outer frame 13 is placed on the workbench such that the rear side of the outer frame 13 faces up. Next, the inner frame 113 is placed on the outer frame 13. At this time, the cylindrical screw-receiving parts 131 set in the outer frame 13 are inserted in the cut-outs 113d of the inner frame 113. Next, the liquid crystal panel 11 having the optical members 15 stacked thereon is placed on the inner edge of the outer frame 13. Next, the periphery of the light guide plate 16 is placed on the pressing part 113c, which is on the inner edge of the inner frame 113. Next, the reflective sheet 20 is placed on the rear surface 16c of the light guide plate 16. Then, the respective LED units LU are placed on the inner frame 113, which is arranged on the long side of the light guide plate 16. At this time, the respective LED units LU are arranged such that the attachment part 192 of the light source support member 19 is above the support part 191. In other words, the respective LED units LU are placed on the inner frame 113 such that the rear side of each of the attachment parts 192 faces up. When the LED units LU are placed on the inner frame 113, the screw holes 194 in the light source support member 19 of the LED unit LU and the screw holes 131b in the screw-receiving parts 131 are aligned with each other. In this manner, the general position of the LED units LU is determined by using the inner frame 113. Thereafter, the chassis 14 is placed on the rear surface 16c of the light guide plate 16 through the reflective sheet 20 so as to cover the rear surface 16c of the light guide plate 16.

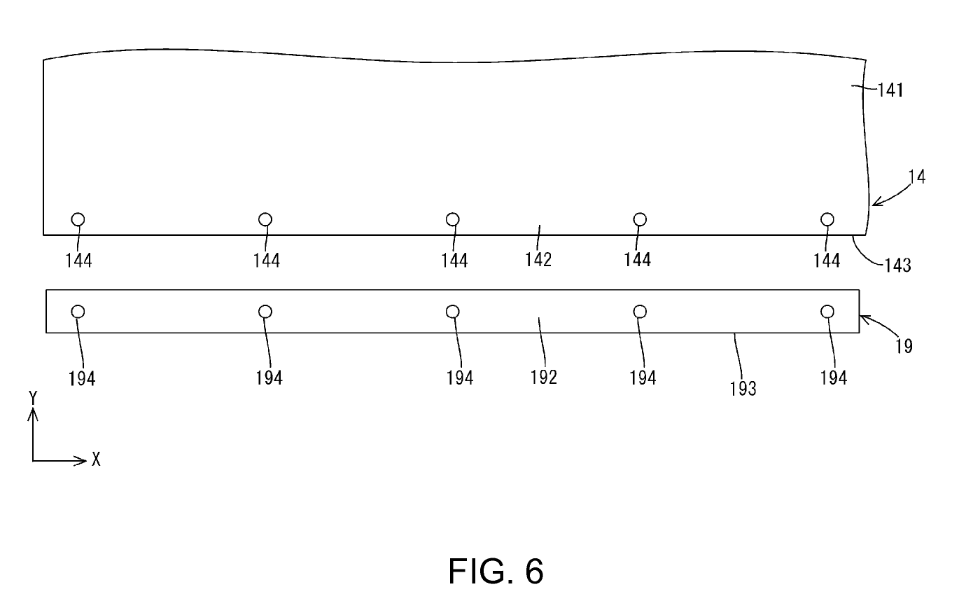

When the chassis 14 is placed on the rear surface 16c of the light guide plate 16, the projecting part 142 of the chassis 14 is placed on the attachment part 192 of the light source support member 19 of the LED unit LU. At this time, the attachment part 192 attaches to the front surface of the strip-shaped (plate-shaped) projecting part 142. FIG. 6 is a view of the projecting part 142 and the attachment part 192 before they are combined together. As shown in FIG. 6, a plurality of screw holes 144 are arranged in a line on the projecting part 142 of the chassis 14. The straight edge 143, which is constituted of the edge of the projecting part 142, also extends in a straight line. The edge (straight edge) 143 of the chassis 14 is ensured to extend in a straight line (linearity) as compared to the edge 193 of the attachment part 192 of the light source support member 19. When the LED substrate 18 is attached to the support part 19, during storage (transportation), and the like, unwanted stress is sometimes exerted on the light source support member 19 and the light source support member 19 becomes warped (deformed). In other words, even if a mold or the like is used in advance to prepare the light source support member 19 having a prescribed shape, the light source support member 19 may already be deformed due to unwanted stress by the time it is attached to the liquid crystal display unit LDU (backlight device 12). The chassis 14, however, normally does not become deformed before being placed on the rear surface 16c of the light guide plate 16 if manufactured in a prescribed shape. Accordingly, in the present embodiment, deformation detection of the light source support members 19 (LED units LU) and confirmation of the attachment position of the light source support members 19 (LED units LU) is performed by comparing the edge (straight edge) 143 of the projecting part 142 of the chassis 14 to the edge 193 of the attachment part 192 of the light source support members 19. The respective screw holes 194 of the attachment part 192 of the light source support members 19 are provided in prescribed locations before the light source support members 19 are deformed.

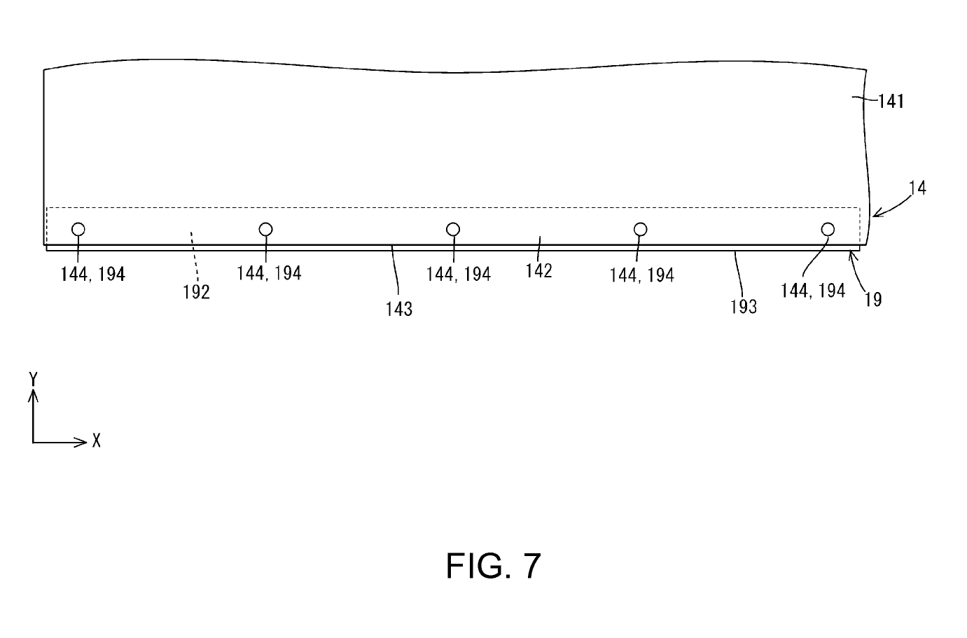

FIG. 7 is a view of the projecting part 142 and the attachment part 192 after being combined together. As shown in FIG. 7, the projecting part 142 of the chassis 14 is placed on the projecting part 142 of the light source support member 19. When the respective screw holes 144 in the projecting part 142 are aligned with the respective screw holes 194 in the attachment part 192, the edge 193 of the attachment part 192 protrudes outwards beyond the projecting part 142 of the chassis 14. In this state, the straight edge 143 of the projecting part 142 and the edge 193 of the attachment part 192 can be visually compared from the rear side of the chassis 14. The edge 193 of the attachment part 192 shown in FIG. 7 is a straight line shape, similar to the straight edge 143 of the projecting part 142. Accordingly, it can be confirmed that no deformation of the light source support member 19 of the present embodiment has occurred. In other words, because no deformation of the light source support member 19 has occurred, there has also been no deformation of the LED substrate 18 supported by the support part 191 of the light source support member 19, and it can be confirmed that the gap between the LEDs 17 on the LED substrate 18 and the light-receiving face 16b of the light guide plate 16 is uniform. After it is confirmed that no deformation of the light source support member 19 has occurred, the screws 21 are inserted into the respective screw holes 144 and 194 and the LED unit LU is fixed to the projecting part 142 of the chassis 14. When the screws 21 are inserted into the respective screw holes 144 and 194 to fix the projecting part 142 to the attachment part 192, the edge 193 is adjusted so as to conform to the straight edge 143 while the screws 21 are engaging the screw-receiving parts 131 and while the straight edge 143 of the projecting part 142 is being compared to the edge 193 of the attachment part 192. In the manner described above, the chassis 14 is attached to the LED unit LU and the outer frame 13 by screws 21 after being placed on the rear surface 16c of the light guide plate 16. The liquid crystal display unit LDU having the backlight device 12 is manufactured through the steps described above.

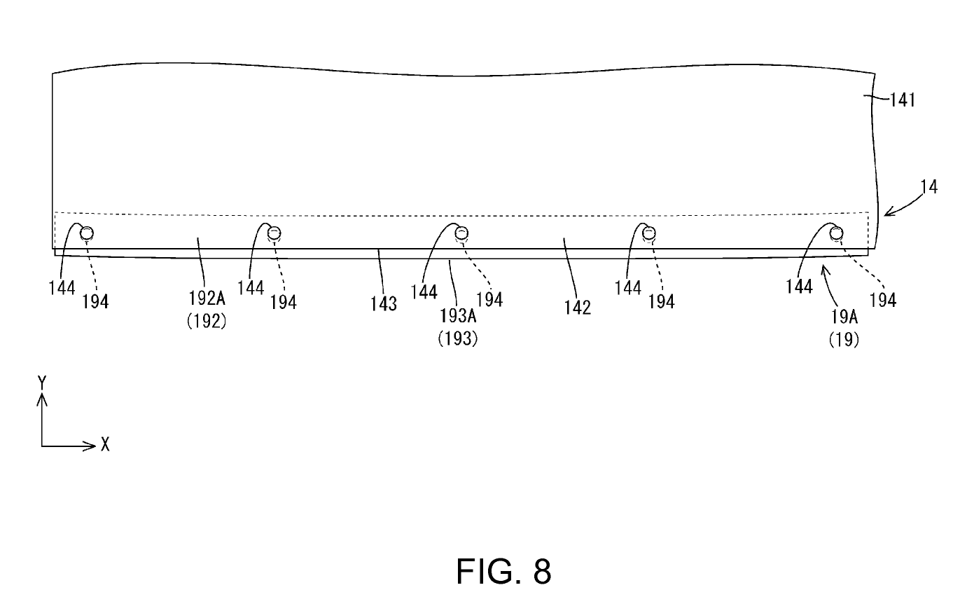

Unlike what is shown in FIGS. 6 and 7, the attachment part 192 of the light source support member 19 sometimes becomes deformed before being attached to the chassis 14. FIG. 8 is a view of a deformed attachment part 192A being covered by the projecting part 142. As shown in FIG. 8, when the respective screw holes 144 and 194 are aligned together, the center of the attachment part 192A sometimes greatly protrudes to outside of the straight edge 143 beyond both edges of the attachment part 192A. In other words, a light source support member 19A (attachment part 192A) shown in FIG. 8 curves outward. In such a case, the deformation of the light source support member 19A can be detected by visually comparing the straight edge 143 of the chassis 14 to an edge 193A of the attachment part 192A from the rear side of the chassis 14. When the light source support member 19A of the LED unit LU is deformed as such, the screws 21 are inserted into the respective screw holes 144 and 194 to fix the chassis 14 to the LED unit LU while external stress is applied to the light source support member 19A to correct the deformation (warp) of the light source support member 19A. At this time, the edge 193A of the light source support member 19A is corrected to conform with the straight edge 143 of the projecting part 142. The edge 193A of the light source support member 19A will then be straight, similar to the edge 193 of the light source support part 19 shown in FIG. 7. Accordingly, even if the light source support member 19A is deformed before being attached to the chassis 14, the gap between the LEDs 17 of the LED unit LU and the light-receiving face 16b of the light guide plate 16 can be uniformly maintained by correcting (fixing) the deformation in this manner so as to conform with the straight edge 143.

When the power source of the liquid crystal display device 10 (television receiver TV) having the liquid crystal display unit LDU manufactured in the above manner is turned ON, power is supplied from the power supply board PWB and the driving of the liquid crystal panel 11 is controlled by various signals from the control board CTB being supplied to the liquid crystal panel 11, and the respective LEDs 17 forming a part of the backlight device 12 are driven. When the respective LEDs 17 are driven and light is emitted from these LEDs 17, light enters the light-receiving faces 16a of the light guide plate 16. The light that has entered is reflected and the like by the reflective sheet 19 or the like on the rear side of the light guide plate 16. The light progresses through the light guide plate 16 and exits from the front surface (light-exiting surface) 16a thereof towards the optical members 15. The light that has exited becomes planar light after passing through the optical members 15 and illuminates a back surface 11b of the liquid crystal panel 11. The liquid crystal panel 11 uses this planar light to perform display on the display surface 11a.

As described above, the backlight device 12 of the present embodiment has a configuration in which the position or deformation of the light source support member 19 fixed to the chassis 14 by screws 21 inserted from the rear side of the chassis 14 can be verified from the rear side of the chassis 14. Therefore, when assembling the backlight device 12, it is possible to fix the light source support member 19 to the chassis 14 while confirming the attachment position of the light source support member 19 from the rear side of the chassis 14. Furthermore, when assembling the backlight device 12, the light source support member 19 can be fixed to the chassis 14 while correcting deformation (warping) of the light source support member 19 to conform with the straight edge 143 of the chassis 14.

The backlight device 12 of the present embodiment, as described above, uniformly maintains the gap between the LEDs 17 of the LED units LU and the light-receiving faces 16a of the light guide plate. Therefore, uneven brightness is prevented from occurring in planar light emitted from the backlight device 12. Uneven brightness is also prevented from occurring in the images displayed on the display surface 11a of the liquid crystal display unit LDU (liquid crystal display device 10).

### Embodiment 2

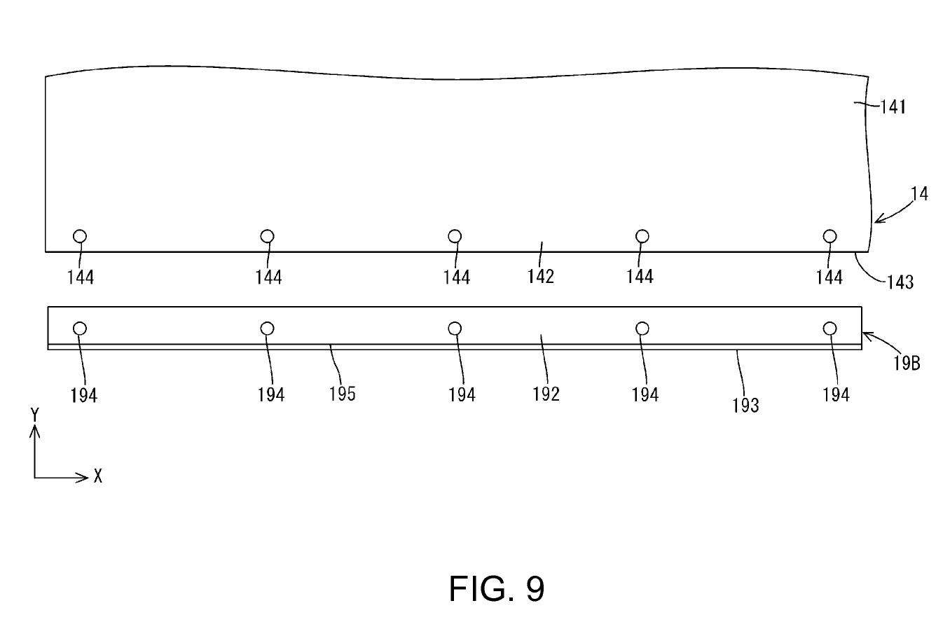

Embodiment 2 of the present invention will be explained below with reference to FIG. 9. In the respective embodiments below, parts that are the same as those in Embodiment 1 will be assigned the same reference characters as Embodiment 1, and detailed descriptions thereof will be omitted. The present embodiment replaces the light source support member 19 of Embodiment 1 with a light source support member 19B. FIG. 9 is a view of a projecting part 142 of a chassis 14 and an attachment part 192 of the light source support member 19B used in the liquid crystal display device (backlight device) of Embodiment 2. As shown in FIG. 9, the light source support member 19B used in the present embodiment has a positioning part 195 on the rear surface of the attachment part 193 provided to the light source support member 19 of Embodiment 1. This positioning part 195 is constituted of a groove provided straight along the lengthwise direction (X axis direction) of the attachment part 193. This positioning part 195 is provided during casting of the light source support member 19B, which uses a mold. When a straight edge 143 of the chassis 14 is attached to this positioning part 195, respective screw holes 144 in the projecting part 142 of the chassis 14 are aligned with respective screw holes 194 in the attachment part 193. The gap between LEDs 17 on LED substrates 18 supported by support parts 191 of the light source support member 19B and light-receiving faces 16a of a light guide plate 16 is adjusted to a prescribed gap in advance. In this manner, the backlight device may be configured such that the attachment position of the LED units LU relative to the chassis 14 can be determined by looking at the light source support member 19B form the rear side of the chassis 14 and aligning the straight edge 143 of the chassis 14 with the straight positioning part 195 provided on the attachment part 193.

### Embodiment 3

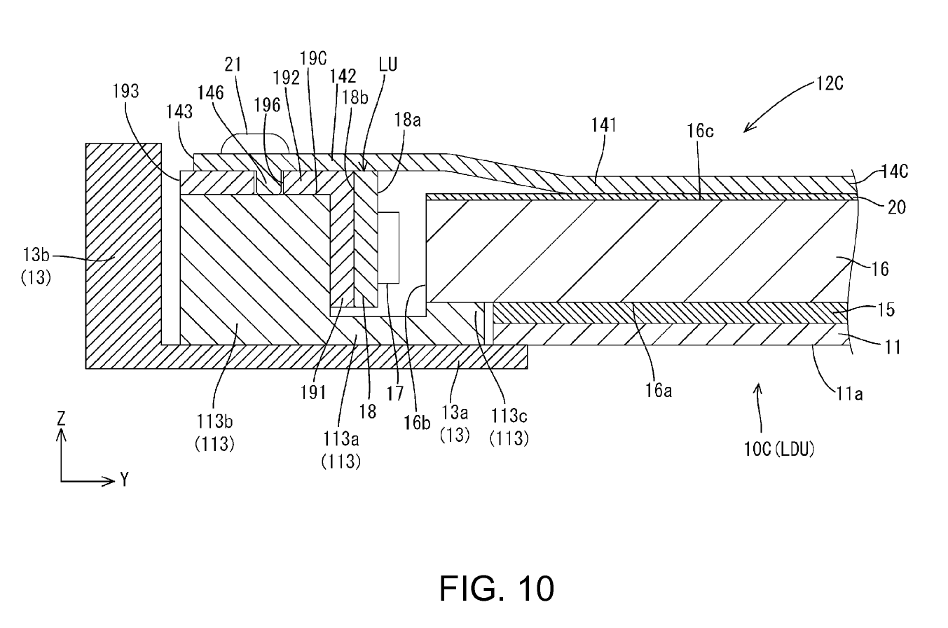

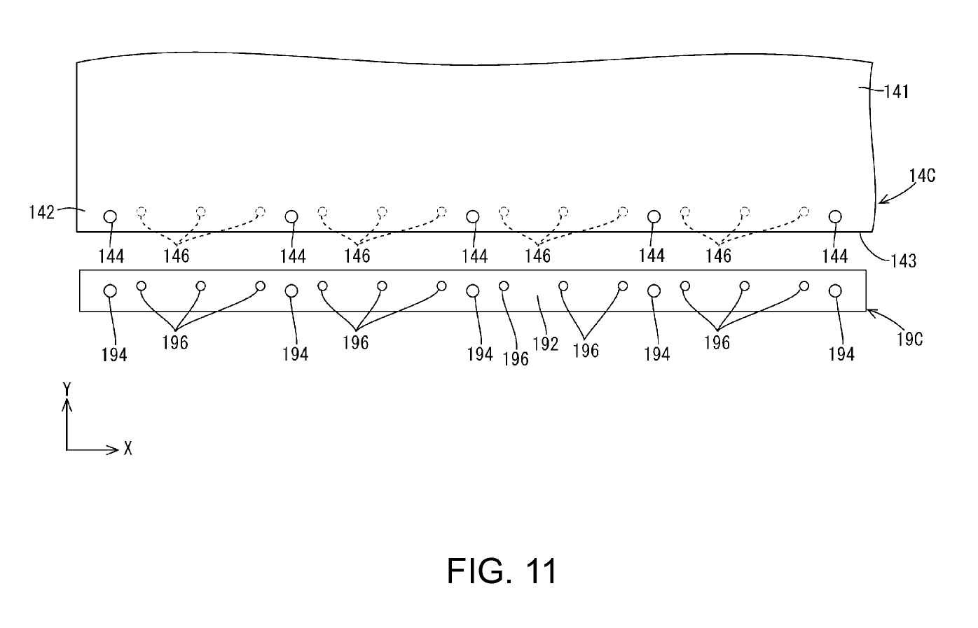

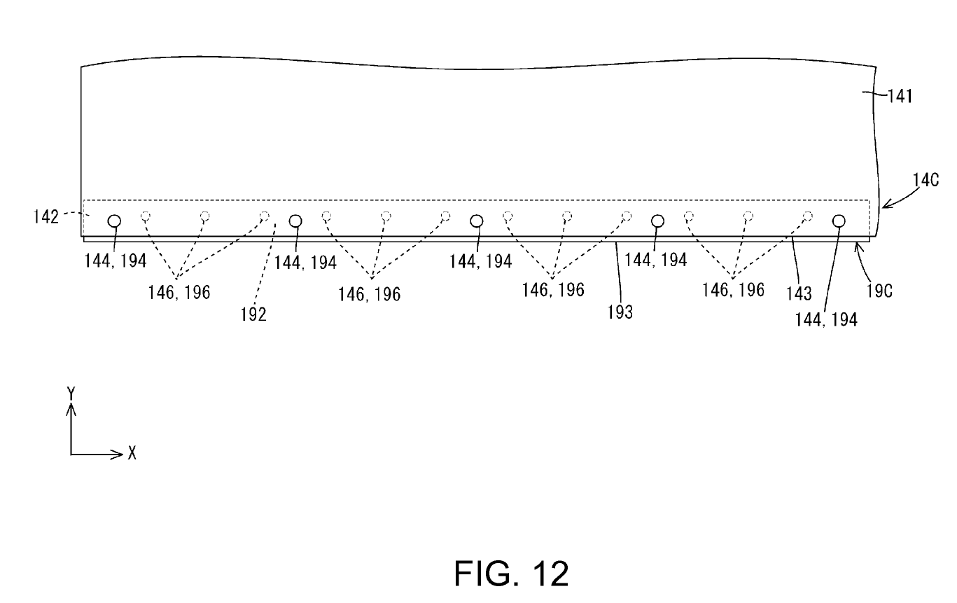

Embodiment 3 of the present invention will be explained below with reference to FIGS. 10 to 12. FIG. 10 is a partial cross-sectional view along the short side direction of a liquid crystal display unit LDU of Embodiment 3, FIG. 11 is a view of a projecting part 142 of a chassis 14C and an attachment part 192 of a light source support member 19C used in a liquid crystal display device 10C of Embodiment 3, and FIG. 12 is a view of the projecting part 142 of the chassis 14C and the attachment part 192 of the light source support member 19C being combined together. FIG. 10 shows a cross-section along the short side direction of the liquid crystal display device 10C (liquid crystal display unit LDU), in a manner similar to FIG. 4, but for convenience of explanation, the portions shown in the long side direction of the liquid crystal display device 10C differ from those shown in FIG. 4 (Embodiment 1).

The basic configuration of the liquid crystal display device 10C (backlight device 12C) is the same as Embodiment 1. The present embodiment, however, differs from Embodiment 1 in that positioning protrusions (first protrusions) 146 are provided on the projecting part 142 of the chassis 14C, and positioning holes (first fitting holes) 196 are provided in the attachment part 192 of the light source support member 19C. An explanation focusing on these differing configurations will be given below.

As shown in FIG. 11, a plurality of the positioning protrusions 146 are provided on the projecting part 142 of the chassis 14C. As shown in FIG. 10, the positioning protrusions 146 are provided on the front side of the projecting part 142. The respective positioning protrusions 146 are arranged on the projecting part 142 in a line along the lengthwise direction. The line constituted of the respective positioning protrusions 146 are arranged in parallel to a straight edge 143 of the chassis 14. In the present embodiment, three each of the positioning protrusions 146 are provided between adjacent screw holes 144 and 144 of the projecting part 142. The positioning protrusions 146 are provided as a part of the projecting part 142. The height (height from the front surface of the projecting part 142) of the positioning protrusions 146 is substantially the same as the thickness of the attachment part 192 of the light source support member 19C. The positioning protrusions 146 are substantially column-shaped.

As shown in FIG. 11, a plurality of the positioning holes 196 are provided in the attachment part 192 of the light source support member 19C. The positioning holes 196 penetrate the attachment part 192 in the thickness direction. The positioning holes 196 are arranged in a line along the lengthwise direction of the attachment part 192. The respective positioning protrusions 146 are fitted into the respective positioning holes 196. The size of the positioning holes 196 is slightly smaller than the positioning protrusions 146, and the positioning protrusions 146 are pressed into the positioning holes 196.

When the projecting part 142 of the chassis 14C having such positioning protrusions 146 is combined with the attachment part 192 of the light source support member 19C having the positioning holes 196, the positioning protrusions 146 are inserted into the positioning holes 196. At this point, positioning is determined by the respective screw holes 144 in the chassis 14C aligning with the respective screw holes 194 in the light source support member 19C. Furthermore, the attachment position of the light source support member 19C to the chassis 14C is determined, and the gap between respective LEDs 17 of an LED substrate 18 attached to the light source support member 19C and a light-receiving face 16a of a light guide plate 16 is also determined. Namely, the position of the positioning protrusions 146 provided on the projecting part 142 and the position of the positioning holes 196 in the attachment part 192 are determined in consideration of a desired attachment position of a pre-configured LED unit LU to the chassis 14C. In this manner, the attachment position of the light source support member 19C of the LED unit LU to the chassis 14C may be determined by using the positioning protrusions 145 and the positioning holes 196. The light source support member 19C of the LED unit LU, after being positioned by the positioning protrusions 145 and the positioning holes 196, is fixed to the chassis 14C by screws 21.

In the present embodiment, however, sometimes the light source support member 19C becomes deformed before being attached to the chassis 14C. In such a case, if the respective positioning protrusions 146 are arranged in a straight line on the light source support member 19C before deformation, then deformation (warping) of the light source support member 19C can be corrected by the respective positioning protrusions 146 fitting into the respective positioning holes 196 arranged in a straight line in the attachment part 192. Accordingly, in the present embodiment, the attachment part 192 of the light source support member 19C can be returned to its original straight shape even if there is deformation after being cast, by using the positioning protrusions 146 and the positioning holes 196.

As described above, in the backlight device 12C of the present embodiment, the gap between the LEDs 17 of the LED units LU and the light-receiving faces 16a of the light guide plate can be uniformly maintained, in a manner similar to Embodiment 1. Therefore, uneven brightness can be prevented from occurring in planar light emitted from the backlight device 12C. Uneven brightness is also prevented from occurring in the images displayed on a display surface 11a of the liquid crystal display unit LDU (liquid crystal display device 10C).

### Embodiment 4

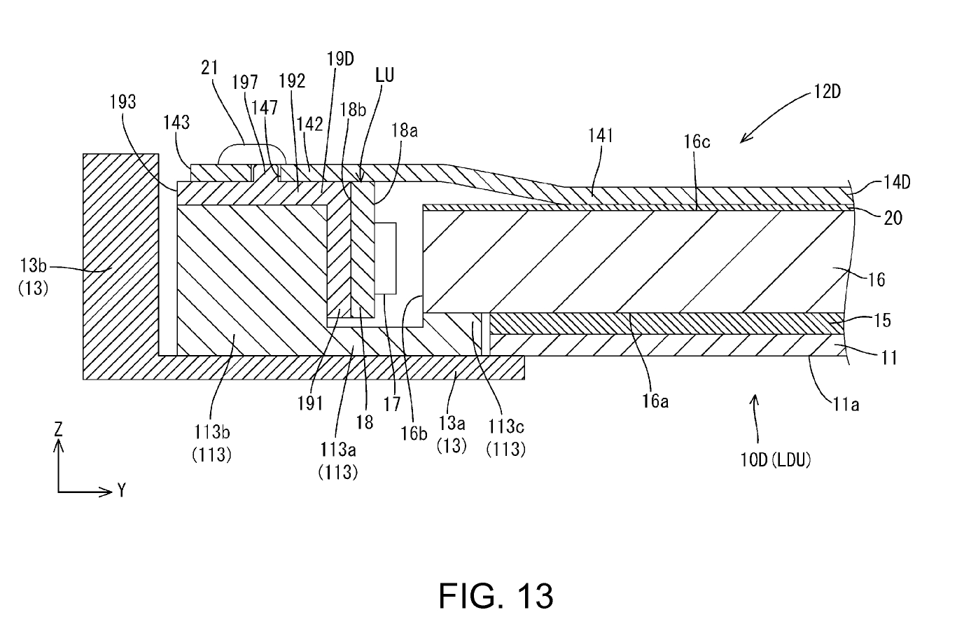

Embodiment 4 of the present invention will be explained below with reference to FIG. 13. FIG. 13 is a partial cross-sectional view along the short side direction of a liquid crystal display unit LDU (liquid crystal display device 10D) according to Embodiment 4. The basic configuration of the liquid crystal display device 10D (backlight device 12D) is the same as Embodiment 3. In the present embodiment, however, positioning holes (second fitting holes) 147 are provided in a projecting part 142 of a chassis 14D instead of the positioning protrusions 146 in Embodiment 3. Furthermore, positioning protrusions (second protrusions) 197 are provided on an attachment part 192 of a light source support member 19D instead of the positioning holes 196 in Embodiment 3.

The positioning holes 147 of the chassis 14D penetrate the projecting part 142 in the thickness direction. A plurality of the positioning holes 147 are provided along the lengthwise direction (X axis direction) of the projecting part 142. The respective positioning holes 147 are arranged in a line. The positioning protrusions 197 of the light source support member 19D are provided on the rear surface of the attachment part 192 and have a substantially column shape. A plurality of the positioning protrusions 197 are provided along the lengthwise direction (X axis direction) of the attachment part 192 of the light source support member 19D. The respective positioning protrusions 197 are arranged in a line. The respective positioning protrusions 197 are pressed into the respective positioning holes 147. In this manner, which is opposite to Embodiment 3, the positioning holes 147 are provided in the chassis 14D side and the positioning protrusions 197 are provided on the light source support member 19D side, and thus, an LED unit LU having the light source support member 19D may be positioned in relation to the chassis 14D.

### Other Embodiments

The present invention is not limited to the embodiments shown in the drawings and described above, and the following embodiments are also included in the technical scope of the present invention, for example.

(1) In the respective embodiments above, the LED units LU were arranged along the two long sides of the light guide plate 16, but in other embodiments the LED units LU may be arranged along one long side of the light guide plate 16, for example. In other embodiments, the LED units LU may be arranged on the short sides of the light guide plate 16.

(2) In the respective embodiments above, the outer frame 13 and the inner frame 113 are used together as a frame-shaped member, but in other embodiments a single frame having the function of the outer frame and the function of the inner frame may be used with the backlight device 12, for example.

(3) In the respective embodiments above, cylindrical (so-called boss-shaped) screw-receiving parts 131 were used, but in other embodiments screw-receiving parts having other shapes may be used.

(4) In the respective embodiments above, the cut-outs 113d for inserting the screw-receiving parts 113 are provided in the inner frame 113, but in other embodiments holes penetrating the inner frame 113 in the thickness direction thereof may be used instead of the cut-outs 113d, for example. The screw-receiving parts 113 may be inserted into these holes.

(5) In the respective embodiments above, two LED units LU are arranged on each long side of the light guide plate 16, but in other embodiments one LED unit longer than the one in Embodiment 1 may be arranged on one long side of the light guide plate.

(6) In Embodiment 2, one connected groove is used with the attachment part 192 of the light source support member 19B as the positioning part 195, but in other embodiments the groove may divided so as to form a broken line shape and used as the positioning part 195, for example. The positioning part 195 may be formed on a prescribed part of the attachment part 192 using a well-known printing technique.

(7) In Embodiment 1, a television receiver was shown as an example of the liquid crystal display device, but in other embodiments the liquid crystal display device may be used with a mobile phone, portable information terminal, or the like, for example. In other embodiments, the display device may not be provided with the tuner.

(8) In Embodiment 1, colored portions of color filters of the liquid crystal panel 11 respectively being three colors, R, G, or B, was shown as an example, but in other embodiments the colored portions may respectively be four or more colors. In other embodiments, the liquid crystal display device may perform black-and-white display.

(9) In Embodiment 1, TFTs were used as the switching elements of the liquid crystal display device, but in other embodiments, switching elements besides TFTs (thin-film diodes (TFDs), for example) may be used.

### DESCRIPTION OF REFERENCE CHARACTERS

10 liquid crystal display device
11 liquid crystal panel
11a display surface
12 backlight device (illumination device)
13 outer frame
131 screw-receiving part
113 inner frame
14 chassis
141 body of chassis
142 projecting part
143 straight edge
144 screw hole in chassis
15 optical members
16 light guide plate
16a light-exiting surface
16b light-receiving face
16c rear surface of light guide plate
17 LED (light source)
18 LED substrate (light source substrate)
19 light source support member
191 support part
192 attachment part
193 edge of light source support member (attachment part)
194 screw hole in light source attachment member
20 reflective sheet
21 screw
131 screw-receiving part
LU LED unit (light source unit)
LDU liquid crystal display unit
TV television receiver

1. An illumination device, comprising:
a light source;
a light guide plate that is a plate-shaped member having a light-receiving face comprising at least one edge face of the light guide plate where light from the light source enters, and a light-exiting surface comprising a front surface of the light guide plate where the light that has entered from the light-receiving face exits;
a chassis having a body covering a rear surface of the light guide plate, a strip-shaped projecting part extending from the body and projecting further outwards than the light-receiving face, and a straight edge comprising an edge of the projecting part and extending in a straight line parallel to the light-receiving face;
a light source support member having a support part supporting the light source such that the light source faces the light-receiving face with a prescribed gap being maintained therebetween, and an attachment part extending from the support part and being attached to a front surface of the projecting part while having an edge protruding further than the straight edge of the chassis, said edge of the attachment part extending in a straight line parallel to said straight edge of the chassis;
screws penetrating the projecting part and the attachment part from a rear surface side of the projecting part; and
screw-receiving parts respectively receiving tips of the screws and clamping the projecting part and the attachment part therebetween.

2. The illumination device according to claim 1,
wherein the projecting part includes a plurality of first penetrating holes along the straight edge of the chassis where the screws are respectively inserted, and
wherein the attachment part includes a plurality of second penetrating holes where the screws are respectively inserted such that the edge of the attachment part is protruding further than the straight edge of the chassis and said edge is extending in a straight line parallel to said straight edge.

3. The illumination device according to claim 1, wherein the attachment part includes a positioning part showing a position of the straight edge of the chassis when the attachment part is attached to the front surface of the projecting part.

4. The illumination device according to claim 1,
wherein the projecting part includes a plurality of first protrusions arranged along the straight edge of the chassis on the front surface of the projecting part, and
wherein the attachment part includes a plurality of first fitting holes that respectively fit with the first protrusions in a state in which the edge of the attachment part is protruding further than the straight edge of the chassis and said edge is extending in a straight line parallel to said straight edge.

5. The illumination device according to claim 1,
wherein the projecting part includes a plurality of second fitting holes arranged along the straight edge of the chassis, and
wherein the attachment part includes a plurality of second protrusions that respectively fit with the second fitting holes such that the edge of the attachment part is protruding further than the straight edge of the chassis and said edge is extending in a straight line parallel to said straight edge.

6. The illumination device according to claim 1, wherein the light source support member is a heat dissipating member.

7. The illumination device according to claim 1, wherein the chassis is casted by a mold.

8. A display device, comprising a display panel that performs display using light from the illumination device according to claim 1.

9. The display device according to claim 8, wherein the display panel is a liquid crystal panel having liquid crystal.

10. A television receiver, comprising the display device according to claim 8.

11. A method of manufacturing an illumination device including a light source; a light guide plate that is a plate-shaped member having a light-receiving face comprising at least one edge face of the light guide plate where light from the light source enters, and a light-exiting surface comprising a front surface of the light guide plate where the light that has entered from the light-receiving face exits; a chassis having a body covering a rear surface of the light guide plate, a strip-shaped projecting part extending from the body and projecting further outwards than the light-receiving face, and a straight edge comprising an edge of the projecting part and extending in a straight line parallel to the light-receiving face; a light source support member, having a support part supporting the light source such that the light source faces the light-receiving face while a prescribed gap is maintained therebetween, and an attachment part extending from the support part and being attached to a front surface of the projecting part while having an edge protruding further than the straight edge of the chassis; screws penetrating the projecting part and the attachment part from a rear surface side of the projecting part; and screw-receiving parts respectively receiving tips of the screws and clamping the projecting part and the attachment part therebetween, the method comprising:
extending the edge of the attachment part protruding further than the straight edge of the chassis such that said edge is in a straight line parallel to said straight edge;
penetrating the projecting part and the attachment part with the screws from the rear surface side of the projecting part; and
clamping the projecting part and the attachment part between the screws and the screw-receiving parts.
